(19) United States
(12) Patent Application Publication
(10) Pub. No.: US 2025/0353208 A1
(43) Pub. Date: Nov. 20, 2025

(54) POWER TOOL

(71) Applicant: Black & Decker, Inc., New Britain, CT (US)

(72) Inventors: Arthur LAUER, Frankfurt am Main (DE); Klaus-Dieter ARICH, Hünstetten-Beuerbach (DE); Ashwin RAJENDRAN, Idstein (DE); Timo RAAB, Mainz (DE)

(21) Appl. No.: 19/210,335

(22) Filed: May 16, 2025

(30) Foreign Application Priority Data
May 17, 2024 (GB) 2407036.9

(51) Int. Cl. B27C 5/10; B25F 5/00

(52) U.S. Cl. CPC B27C 5/10; B25F 5/006

(57) ABSTRACT

A power tool including a housing and a motor mounted in the housing and operatively connected to a tool holder arranged to hold a cutting tool bit. At least one guide post has a longitudinal axis slidably mounted to the housing such that the housing is moveable in a direction parallel with the longitudinal axis between a retracted position and a plunged position. A base portion is fixed to the at least one guide post and a slide bearing is mounted between the housing and the at least one guide post. The slide bearing is slidable with respect to the at least one guide post when the housing moves between the retracted position and the plunged position. The slide bearing includes at least one dampening element arranged to dampen movement of the at least one guide post with respect to the housing in a direction perpendicular to the longitudinal axis.

### CROSS-REFERENCE TO RELATED APPLICATIONS

The present application claims priority to United Kingdom Patent Application No. 2407036.9 filed on May 17, 2024, which is herein incorporated by reference in its entirety.

### BACKGROUND OF THE INVENTION

### Field of the Invention

The present disclosure relates to a power tool. In particular, the present disclosure relates to routers and plunge routers.

### Description of the Related Art

A power tool such as a router may be utilised by tradesmen, craftsmen, hobbyists, and other users to perform various tasks. For instance, a router may be used to perform intricate cutting projects, such as decorative profiles and trimming laminates on the edges or perimeters of a workpiece. A router also may be utilised to form grooved areas in woodworking and other material as well as to remove excess material on workpieces. Routers may utilise various types of cutting tools or router bits in order to perform these and other types of tasks.

One type of router is a plunge router whereby the user can move the housing and the cutting tool towards the base. A problem with plunge routers is that the plunge mechanism requires precise tolerances to enable a guide post to smoothly slide with respect to a housing. It is known to provide a bearing to facilitate the guide post sliding with respect to the housing e.g. as shown in DE 10 2011 082 271 A1. However, a problem DE 10 2011 082 271 A1 is that the housing can rotate about the bearing if the tolerances are incorrect. This means that the power tool feels sloppy when cutting a workpiece and can lead to inaccurate cuts.

### SUMMARY OF THE INVENTION

In a first aspect of the disclosure there is provided a power tool comprising: a housing; a motor mounted in the housing and operatively connected to a tool holder arranged to hold a cutting tool bit; at least one guide post having a longitudinal axis slidably mounted to the housing such that the housing is moveable in a direction parallel with the longitudinal axis between a retracted position and a plunged position; a base portion fixed to the at least one guide post; a slide bearing mounted between the housing and the at least one guide post wherein the slide bearing is slidable with respect to the at least one guide post when the housing moves between the retracted position and the plunged position; wherein the slide bearing comprises at least one dampening element arranged to dampen movement of the at least one guide post with respect to the housing in a direction perpendicular to the longitudinal axis.

Optionally, at least one dampening element is configured to engage an interior surface of the housing.

Optionally, the slide bearing comprises a first groove for receiving at least one dampening element.

Optionally, at least one dampening element is an O-ring mounted on an exterior surface of the slide bearing.

Optionally, the slide bearing comprises a first dampening element and a second dampening element.

Optionally, the second dampening element is configured to engage an interior surface of the housing.

Optionally, the slide bearing comprises a second groove for receiving the second dampening element.

Optionally, the second dampening element is an O-ring mounted on an exterior surface of the slide bearing.

Optionally, the first dampening element and the second dampening element are positioned equidistant from a midpoint of the slide bearing along a bearing longitudinal axis.

Optionally, the first dampening element and the second dampening element project the same distance from the exterior surface of the slide bearing.

Optionally, the slide bearing comprises an internal chamfer at a first bearing end and a second bearing end.

Optionally, the housing comprises a shoulder portion for receiving the slide bearing.

Optionally, an internal guide post is mounted to the housing and configured to move within the at least one guide post when the housing moves between the retracted position and the plunged position.

Optionally, the slide bearing does not dampen movement of the at least one guide post with respect to the housing in a direction parallel to the longitudinal axis.

Optionally, the power tool comprises a housing return spring configured to bias the housing towards the retracted position.

Optionally, the power tool is a router, a plunge router, a plunge saw, a drill, a multitool, or an oscillating tool.

### BRIEF DESCRIPTION OF THE DRAWINGS

Examples are described in more detail below with reference to the appended drawings.

FIG. 1 is a front view of a power tool according to an example;

FIG. 2 is a rear cross-sectional view of a power tool according to an example;

FIG. 3 is a plan view of a power tool according to an example;

FIG. 4 is a side view of a power tool according to an example;

FIG. 5 is a close-up perspective view of the partially disassembled power tool according to an example;

FIG. 6 is a close-up cross-sectional view of the power tool according to an example; and

FIGS. 7a, 7b and 7c respectively show a perspective view, a side view and a cross-sectional view of a bearing used in the power tool according to an example.

### DESCRIPTION OF THE INVENTION

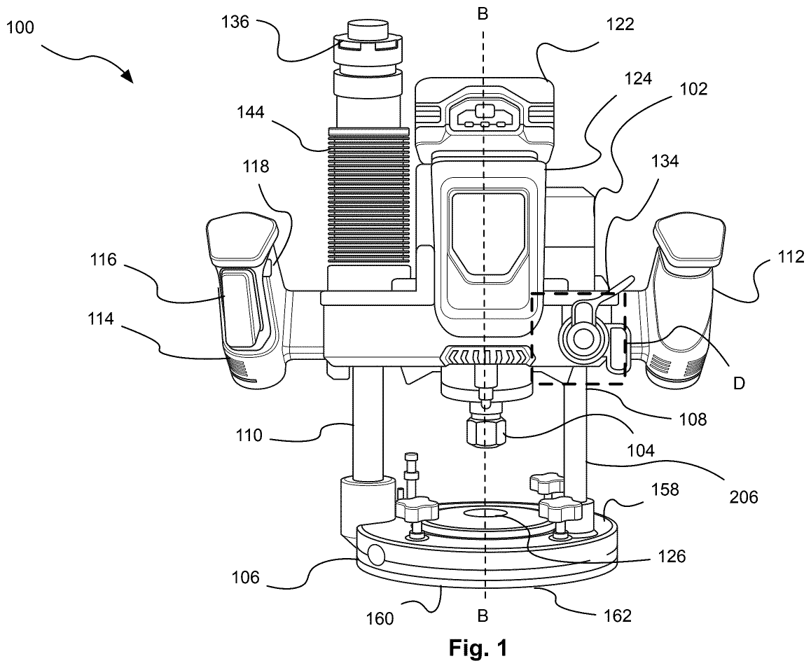

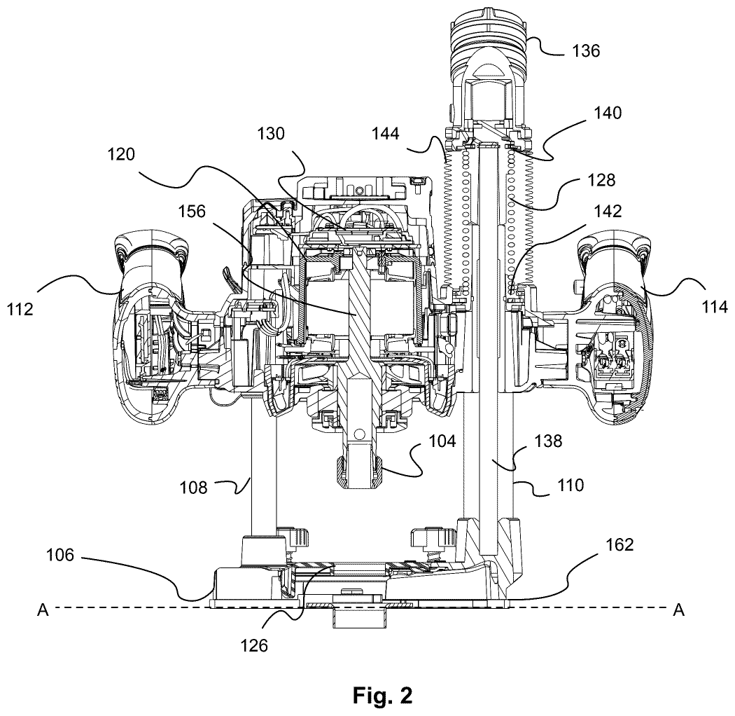

FIG. 1 shows a front view of a power tool 100 according to an example. FIGS. 2, 3 and 4 also respectively show a front cross-sectional view, a plan view, and a side view of the same power tool 100. The power tool 100 as shown in FIG. 1 is a router 100. Specifically, the power tool 100 is a plunge router 100. Whilst the power tool 100 can be a router 100, in other examples any other type of power tool 100 can be used such as a plunge saw, a drill, a multitool, or an oscillating tool mounted on a plunge base portion 106. Hereinafter, the term power tool 100 will be used.

The power tool 100 comprises a housing 102. The housing 102 comprises a clam shell type construction having two halves which are fastened together. The halves of the housing 102 are fastened together with screws but in alternative examples any suitable means for fastening the housing 102 together may be used such as glue, clips, bolts and so on. For the purposes of clarity, the fastenings in the housing 102 are not shown. The housing 102 extends along a longitudinal axis B-B. The longitudinal axis B-B as shown in FIG. 1 is also the rotational axis B-B of the power tool 100.

A motor 120 (best shown in FIG. 2) is mounted in the housing 102 for driving a tool holder, e.g., a collet 104. The motor 120 is optionally mounted within a motor housing (not shown). The motor housing may be mounted to the housing 102. The motor 120 may be any suitable type of electric motor, such as a brushed or brushless DC motor, an AC motor, a stepper motor, or other types of motors known in the art. Optionally, the motor housing is mounted to the housing 102 via dampeners e.g. rubber mounts (not shown) to reduce the vibration transmitted from the motor 120 to the housing 102 and, in turn, to the user.

The motor 120 is operatively connected to the collet 104 through a drive shaft 156, which transmits the rotational movement of the motor 120 directly to the tool holder e.g., the collet 104. The drive shaft 156 may comprise one or more bearings to decrease friction and ensure smooth rotation of the collet 104.

The motor 120 may optionally comprise various cooling components, such as fans or cooling fins, to dissipate heat generated during operation. These cooling components may be encased within the motor housing or the housing 102 of the power tool 100 and may be integrated into the design of the motor 120 itself.

A cutting tool bit (not shown) can be mounted in the collet 104 for engaging a workpiece (not shown). Typically, the cutting tool is a cutting tool bit for a power tool 100. In some examples the cutting tool bit is a router bit such as an upcut spiral router bit, a downcut spiral router bit, a straight router bit, a cove router bit, a chamfer router bit, a rabbeting router bit, a roundover router bit, a beading router bit, an ogee router bit or a panel raising router bit. Any other suitable router cutting tool bit can be mounted in the collet 104.

The collet 104 may be a cylindrical component that contains an inner bore to accommodate and grip the shank of the cutting tool bit. The collet 104 is known and will not be discussed in any further detail.

As shown in FIG. 1, the power tool 100 comprises a base portion 106 for engaging the workpiece. The base portion 106 comprises a base aperture 126 through which the cutting tool bit can project e.g., when the user plunges the housing 102 towards the base portion 106 and then the cutting tool bit projects through the base aperture 126. The base portion 106 is mounted to the housing 102 via first and second guide posts 108, 110. The first and second guide posts 108, 110 are slidably mounted to the housing 102 for adjusting the relative distance of the base portion 106 from the collet 104. In some examples, the first and second guide posts 108, 110 are removable. This means that the power tool 100 can be used without the base portion 106 engaging the workpiece.

The housing 102 comprises a first handle 112 and a second handle 114 for the user to grip during operation. The first handle 112 and the second handle 114 have a different arrangement. In some examples, a main trigger switch 116 for operating the power tool 100 is mounted within the second handle 114. In some examples, the second handle 114 also comprises a lock button 118 for selectively locking the main trigger switch 116 into an “ON” status. This means that the user does not have to constantly keep pressure maintained on the main trigger switch 116 during operation of the power tool 100. In some examples, the main trigger switch 116 can be replaced with a momentary switch (not shown).

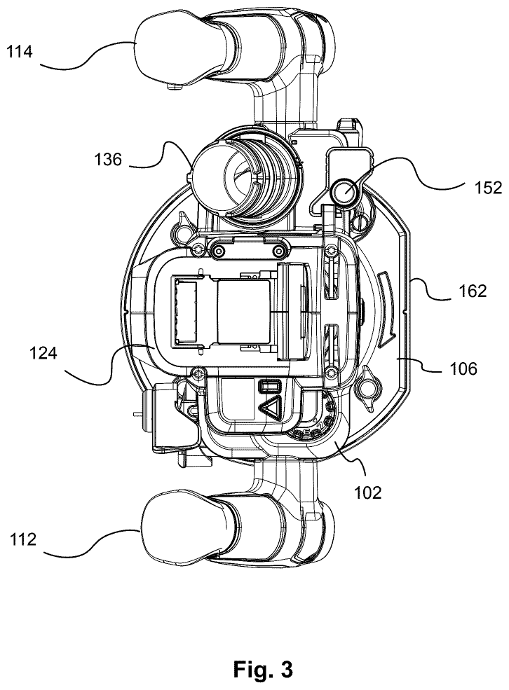

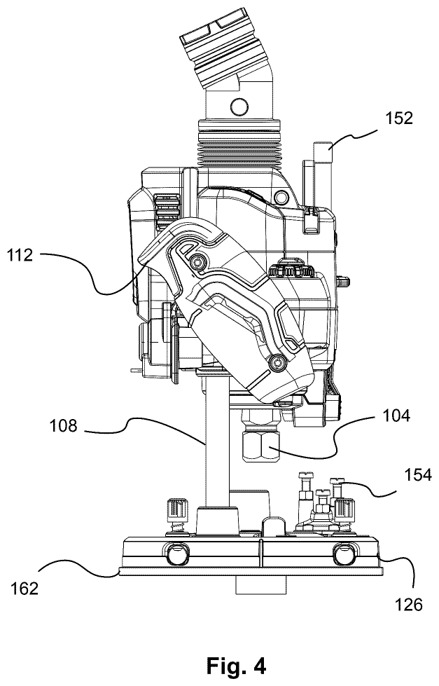

The user can hold both the first handle 112 and the second handle 114 to grip the power tool 100 during operation thereof. The first handle 112 and the second handle 114 optionally comprise a clam shell arrangement. As shown in FIGS. 3 and 4, the first handle 112 and the second handle 114 comprise a “T-shaped” profile. This means that the first handle 112 and the second handle 114 have an ergonomic profile and are comfortable when the user wraps their fingers and thumbs around the first and second handles 112, 114.

Indeed, the first handle 112 and the second handle 114 are separate handle elements that are mountable to the housing 102. Accordingly, the separate parts of the first handle 112 on the second handle 114 can be assembled before the first and second handles 112, 114 are mounted on the housing 102.

In some examples, the first and second handles 112, 114 are mounted to the housing 102 with one or more screw fastenings. In some other examples, any other type of fastening arrangement can be used, e.g., adhesive, clips, or clamps or a friction fit etc.

The motor 120 is electrically connected to an electric power source 122. In some examples, the electric power source 122 is a mains electrical supply. In some other examples, the electrical power source 122 is preferably a battery 122 as shown in e.g., FIG. 1. The battery 122 can be removably mountable to the housing 102 or integral to the housing 102. In some examples, the power tool 100 can be powered either from both a battery 122 and/or a mains electrical supply. The motor 120 is connected to a controller 130 (best shown in FIG. 2) mounted on a PCB in the housing 102. The controller 130 is configured to issue control instructions to the motor 120 in dependence of the user actuating the main trigger switch 116.

The battery 122 as shown in FIG. 1 is securely mounted to a top portion 124 of the housing 102. The battery 122 is configured to power the motor 120 and other electronic components. The battery 122 may comprise lithium-ion cells, nickel-metal hydride cells, or any other type of rechargeable or non-rechargeable power source.

As mentioned above, the power tool 100 as shown in FIG. 1 and the other Figures is optionally a plunge router 100. However, in some examples, the power tool 100 is not a plunge router 100. Accordingly, the power tool 100 can be selectively operated in different modes. In a first mode, the power tool 100 is in a locked position. In the locked position, the first and second guide posts 108, 110 are fixed with respect to the housing 102. This means that the housing 102 and the collet 104 are fixed with respect to the base portion 106. Accordingly, the cutting tool (not shown) can be maintained at a set height above the workpiece. This means that the user of the power tool 100 can select how far the cutting tool projects through the aperture in the base portion 106.

In a second mode, the power tool 100 is in an unlocked position. In the unlocked position the first and second guide posts 108, 110 are slidable with respect to the housing 102. This means that the user can push down on the first and second handles 112, 114 and the first and second guide posts 108, 110 slide into or through the housing 102. In this way, the distance between the base portion 106 and the housing 102 can be adjusted. This means that the user can position the power tool 100 above the workpiece and then push the housing 102 towards the workpiece and the cutting tool plunges into the workpiece.

As discussed hereinafter, the power tool 100 is configured to be set in a plurality of unlocked positions for different operation modes of the power tool 100.

The user can select between the locked and unlocked position of the power tool 100 by using a locking system (not shown) mounted on the power tool 100. In some examples, the locking system is actuatable with a locking lever 134.

FIG. 1 shows the locking lever 134 in a locked position. In some examples, the locking lever 134 is in the locked position in a vertical orientation. The locking lever 134 is mechanically coupled to the first and/or second guide posts 108, 110 such that relative movement of the first and second guide posts 108, 110 is prevented when the locking lever 134 is in the locked position.

In some examples, the locking lever 134 actuates a locking bolt (not shown) to engage the first guide post 108 or the second guide post 110. In this way, the locking bolt exerts a frictional force against the first or second guide posts 108, 110 when the locking lever 134 is in the locked position. Alternatively, the locking bolt can engage a detent or a hole in the first guide post 108 or the second guide post 110.

Accordingly, when the locking lever 134 is in the locked position the locking bolt clamps against or engages the first or second guide posts 108, 110 preventing relative movement therebetween. In some examples the locking lever 134 optionally engages a reciprocal hole or detent (not shown) in the second guide post 110 and the housing 102. In other examples, an additional second locking bolt (not shown) is used to also engage with the first guide post 108 such that both the first and the second guide posts 108, 110 are locked at the same time. In other examples, other mechanisms can be used to lock the first and second guide posts 108, 110 such as a latch-catch mechanism, a ball bearing engaging a detent in the first and second guide posts 108, 110 or any other suitable mechanism.

The locking lever 134 is moveable between the locked position shown in FIG. 1 and an unlocked position (not shown). In some examples, the locking lever 134 is rotatable between the locked position and the unlocked position about a rotational axis of the locking lever 134. In some other examples, the locking lever 134 is slidable between the locked position and the first and second unlocked positions. Mechanical linkages (not shown) may be coupled between the locking lever 134 and the locking bolt for actuating engagement between the locking bolt and the first and second guide posts 108, 110.

When the user plunges the housing 102 towards the base portion 106, the collet 104 and the cutting tool project through the base aperture 126. A housing return spring 128 is optionally shown in FIG. 2 as is fixed with respect to the first guide post 108 at a first spring end 140 and connected to the housing 102 at a second spring end 142. In some examples the housing return spring 128 is fixed with respect to the first guide post 108 at a first spring end 140 with a first C-clip (not shown) and fixed with respect to the housing 102 at a second spring end 142 with a second C-clip (not shown). Other types of fasteners can be used instead of the first and second c-clips. Accordingly, when the housing 102 is moved towards, the base portion 106, the housing return spring 128 extends and exerts a return force on the housing 102 to return the unplunged position (e.g., the power tool 100 as shown in FIG. 1). The housing return spring 128 is shrouded with a bellows 144 to prevent ingress of dirt, debris, or moisture into the housing return spring 128 or other parts of the power tool 100.

In order to adjust the depth of the plunge e.g., how far the collet 104 projects through the base aperture 126, the housing 102 comprises a depth rod 152. The depth rod 152 is configured to engage one or more depth screws 154 of a plunge depth stop mounted on the base portion 106. When the housing 102 is plunged towards the base portion 106, the housing 102 is prevented from moving further towards the base portion 106 when the depth rod 152 engages the depth screws 154 of the plunge depth stop. The amount the depth rod 152 extends towards the base portion 106 is adjustable by the user. Furthermore, the amount the depth screws 154 project towards the housing 102 from the base portion 106 are also adjustable by the user. For the purposes of clarity only one of the depth screws 154 are labelled. The plunge depth stop, the depth screws 154 and the depth rod 152 are known and will not be described in any further detail.

Turning back to FIG. 1, the power tool 100 comprises a dust extraction conduit 136. The dust extraction conduit 136 is connectable to a vacuum source such as a workshop vacuum. The first guide post 108 is hollow and comprises a first guide post conduit 138 which is in fluid communication with the dust extraction conduit 136 at a first end of the first guide post 108. The second end of the first guide post 108 is in fluid communication with the base portion 106 and the cutting tool. In this way, the first guide post conduit 138 couples the vacuum source via the dust extraction conduit 136 to the base portion 106. This means cutting chips and other debris from the workpiece can be collected and extracted during operation.

The base portion 106 provides a stable and flat surface in a plane parallel with axis A-A (as shown in FIG. 2). The base portion 106 is arranged to be positioned and secured against the workpiece during operation of the power tool 100. The base portion 106 may comprise a first base side 158 facing away from the workpiece, and a second base side 160 facing towards the workpiece. The base portion 106 may be formed from any suitable material such as metal, plastic, composite, or any combination thereof. The dimensions and geometrical features of the base portion 106 may be configured to ensure proper compatibility with a variety of accessories, as discussed below.

The base portion 106 may optionally comprise a plurality of mounting features, such as holes, slots, or recesses, which enable the secure attachment of other components such as a sub-base adapter 162. These mounting features may be arranged in a predetermined pattern or layout, which corresponds to complementary features on the sub-base adapter 162 for proper alignment and mounting.

The base portion 106 of the power tool 100 may be integrally formed with the housing 102 or may be a separate component that is securely attached or connected to the main body of the housing 102 as shown in the accompanying Figures. FIG. 1 shows the first guide post 108 and the second guide post 110 fixed with respect to the base portion 106.

The problem with known plunge routers is that the plunge mechanism requires precise tolerances to enable the first and second guide posts 108, 110 to smoothly slide with respect to the housing 102. This means that the first or second guide posts 108, 110 can move unintentionally. For example, the first or second guide posts 108, 110 can move in a direction perpendicular to the longitudinal axis B-B and parallel to the axis A-A. This means that the housing 102 can “rock” from side to side about the first or second guide post 108, 110. This causes the collet 104 and the cutting bit to be misaligned with the workpiece which results in imprecise cuts or damages the workpiece.

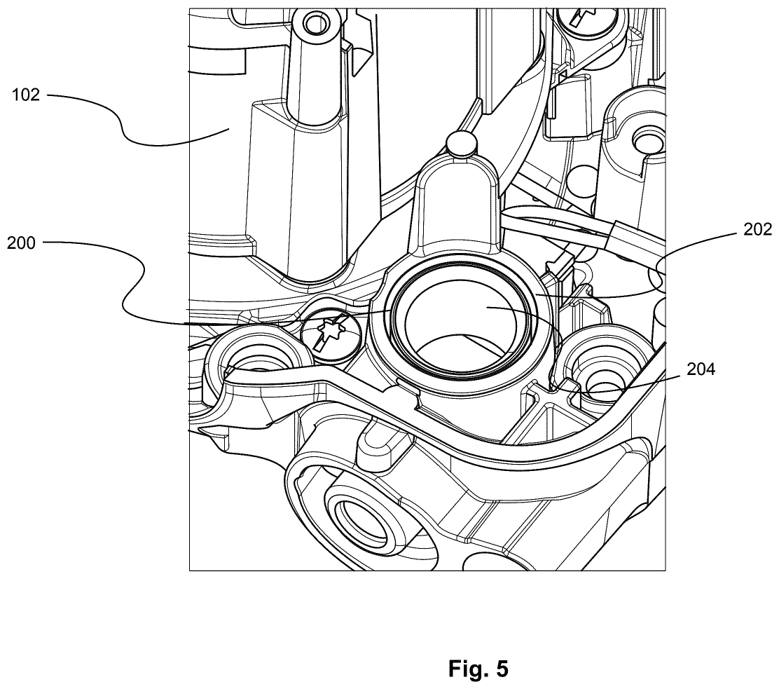

The examples as shown in the figures address this issue by providing a slide bearing 200 to limit lateral movement of the first guide post 108 with respect to the housing 102. Reference will now be made to FIGS. 5, 6 and 7a to 7c to describe the slide bearing 200 in more detail.

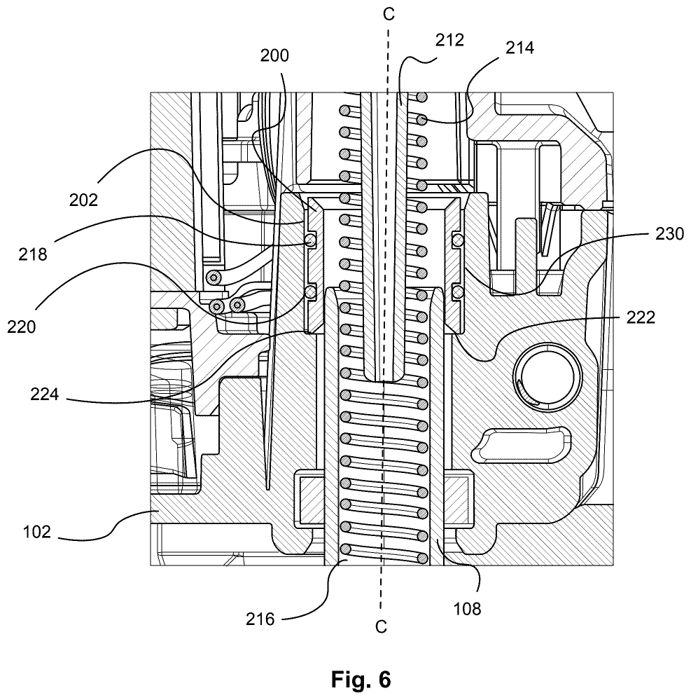

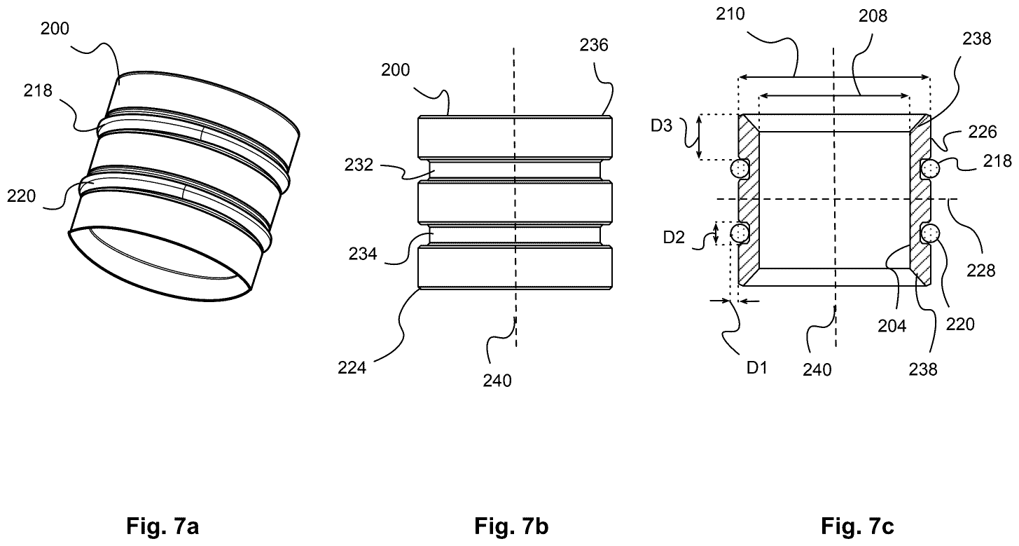

FIG. 5 shows a close-up perspective view of the partially disassembled power tool 100. FIG. 6 shows a close-up cross-sectional view of the power tool 100 with the slide bearing 200 mounted on the first guide post 108. FIG. 6 is a crosse-sectional view of the area as indicated in FIG. 1 with the dotted box labelled D. FIGS. 7a, 7b and 7c respectively show a perspective view, a side view and cross-sectional view of the slide bearing 200 in isolation without showing the power tool 100.

Turning to FIG. 5, the slide bearing 200 will be discussed in more detail. The first guidepost 108 and the base are not shown in FIG. 5 for the purposes of clarity. The slide bearing 200 is shown mounted in a reciprocal bearing hole 202 in the housing 102. The reciprocal bearing hole 202 is slightly larger in diameter than the outer diameter 210 of slide bearing 200 itself. In some examples the outer diameter 210 of the slide bearing 200 is 18.00 mm±0.10.

The slide bearing 200 as shown in FIG. 5 is configured to receive the first guidepost 108. The slide bearing 200, whilst shown in the context of slidably engaging the first guidepost 108, can also be used to slidably engage the second guidepost 110. The examples as discussed herein show a single slide bearing 200 mounted on the first guidepost 108. However, in other examples there can be two slide bearings 200 which are respectively mounted on the first guidepost 108 and the second guidepost 110. In the example where two slide bearings 200 are used respectively for the first and second guideposts 108, 110, the outer diameters 210 and the inner diameters 208 of the slide bearings 200 may have to be modified to accommodate different diameters of the respective first and second guide post 108, 110.

The slide bearing 200 comprises an inner engagement surface 204, which is configured to slidably engage an outer guide post surface 206 of the first guidepost 108. The inner diameter 208 of the slide bearing 200 is slightly larger than the diameter of the first guidepost 108. The inner diameter 208 of the slide bearing 200 is shown in FIG. 7c. In some examples the inner diameter 208 of the slide bearing 200 is 14.15 mm±0.05

The slide bearing 200 is mounted in the reciprocal bearing hole 202. This means that the slide bearing 200 moves together with the housing 102 when the housing 102 moves between the retracted position and the plunged position.

The slide bearing 200 will now be discussed in more detail with reference to FIG. 6.

As mentioned above, the slide bearing 200 is configured to limit movement of the first guide post 108 with respect to the housing 102 in a direction perpendicular to the longitudinal axis A-A.

In particular, the slide bearing 200 dampens movement of the first guide post 108. The slide bearing 200 comprises at least one dampening element 218, which dampens movement in a direction perpendicular to the longitudinal axis A-A.

In FIG. 6, the first guide post 108 is shown in a cross-sectional view and extends along a guide post axis C-C. The first guide post 108 is hollow and is configured to receive a first guide post return spring 214 which is positioned in a first guide post conduit 216. The first guide post return spring 214 is configured to urge the housing 102 towards the retracted position. In this way, the first guide post return spring 214 performs a similar function to the housing return spring 128 as discussed above.

The first guide post conduit 216 is also configured to receive an internal guide post 212. The internal guide post 212 is fixed with respect to the housing 102 and moves together with the housing 102 when the housing 102 moves from the retracted position to the plunged position.

As shown in FIG. 6, the slide bearing 200 is seated within the reciprocal bearing hole 202 and a first bearing end 224 engages a shoulder portion 222. Accordingly, the slide bearing 200 is prevented from moving in an axial direction parallel to the guide post axis C-C towards the base portion 106 because the first bearing end 224 is engaged with the shoulder portion 222.

The first dampening element 218 is configured to dampen lateral movement of the slide bearing 200 and the first guide post 108 in perpendicular to the guide post axis C-C and the bearing longitudinal axis 240.

In some examples, the first dampening element 218 is resiliently deformable and is configured to exert a restoring force on the slide bearing 200. This means that the slide bearing 200 returns to a neutral position in the middle of the reciprocal bearing hole 202 when no load is applied to the slide bearing 200 in a lateral direction perpendicular to the guide post axis C-C.

In some examples the first dampening element 218 is made from one or more of the following materials: silicone, ethylene propylene, neoprene, polyurethane, nitrile buna, fluorocarbon elastomers, butadiene rubber or any other suitable material. Alternatively, in other examples, the first dampening element 218 can be any suitable dampening arrangement e.g. a plurality of circumferentially mounted springs e.g. compression springs (not shown).

The slide bearing 200 dampens movement of the first guide post 108 in a direction perpendicular to the longitudinal axis C-C of the first guide post 108. However, in some examples the slide bearing 200 does not dampen movement of the first guide post 108 with respect to the housing 102 in a direction parallel to the longitudinal axis C-C of the first guide post 108. This is because dampening in a direction parallel to the longitudinal axis C-C of the first guide post 108 is not necessary. This means that the first and second dampening elements 218, 220 can be more compact when combined with the slide bearing 200.

The first dampening element 218, as shown in FIG. 6, is a first O-ring 218. The first O-ring 218 is circumferentially mounted on the exterior surface 226 of the slide bearing 200. The first O-ring 218 is configured to deform when the first guide post 108 exerts a force against the slide bearing 200.

The slide bearing 200 in some examples also comprises a second dampening element 220. The first dampening element 218 and the second dampening element 220 are the same and perform the same dampening function. The second dampening element 220 in some examples is a second O-ring 220. Similar to the first O-ring 218, the second O-ring 220 is also circumferentially mounted on the exterior surface 226 of the slide bearing 200. By providing a second dampening element 220 in addition to the first dampening element 218, this prevents the slide bearing 200 from pivoting within the reciprocal bearing hole 202. This ensures that the slide bearing 200 remains parallel with the guide post axis C-C during operation of the power tool 100.

In some examples the slide bearing 200 comprises a single dampening element 218 e.g. only the first dampening element 218. For example, the single dampening element 218 can be the first O-ring 218. In order for the slide bearing 200 not to pivot about the first O-ring 218, the first O-ring 218 may be positioned along a slide bearing midpoint 228 of the slide bearing 200 along a bearing longitudinal axis 240 as shown in FIG. 7C. Providing a single first O-ring 218 may be less preferable because this may be harder to assemble precisely without the slide bearing 200 being prone to rocking.

The bearing longitudinal axis 240 is parallel to the guide post axis C-C when the slide bearing 200 is mounted in the reciprocal bearing hole 202. The first dampening element 218 and the second dampening element 220 maintain the position of the slide bearing 200 with respect to the housing 102 such that the bearing longitudinal axis 240 remains parallel with the guide post axis C-C. This means that the first guide post 108 does not jam in the slide bearing 200.

Optionally, the first dampening element 218 and the second dampening element 220 may comprise an engagement surface (not shown) configured to engage the interior surface 230 of the housing. The engagement surface may comprise a profile to match the profile of the interior surface 230 of the housing 102. This may further prevent rocking of the slide bearing 200 with respect to the housing 102 when the first guide post 108 moves.

Whilst the figures show that the first dampening element 218 and the second dampening element 220 are a first and second O-ring 218, 220 respectively, in other examples the first and second dampening elements 218, 220 can be any suitable element for dampening the lateral movement of the slide bearing 200. In some examples the slide bearing 200 comprises a single dampening element 218 which circumferentially covers the entire of the exterior surface 226 of the slide bearing 200. For example, the slide bearing 200 comprises an exterior deformable sleeve (not shown). The exterior sleeve deforms when the first guide post 108 exerts a force in a direction perpendicular to the guide post axis C-C. Accordingly, the first and/or second dampening elements 218, 220 can be integral with the slide bearing 200.

In other examples there can be additional dampening elements which are not shown in the figures. For example, in FIGS. 6, two O-rings, e.g. the first O-ring 218 and the second O-ring 220 are provided on the exterior surface 226 of the slide bearing 200. In other examples there can optionally be additional O-rings e.g. a third O-ring, a fourth O-ring etc.

Furthermore, in other examples the first dampening element 218 and the second dampening element 220 do not cover the entire circumference of the slide bearing 200. Alternatively, the first and second dampening elements 218 and 220 are a plurality of discrete dampening elements positioned circumferentially around the exterior surface 226 of the slide bearing 200. For example, the first and second dampening elements 218, 220 do not form one contiguous circumferential element around the slide bearing 200.

However, the first O-ring 218 and the second O-ring 220 may be preferable because the first O-ring 218 and the second O-ring 220 engage the interior surface 230 of the housing 102 around the entire circumference of the slide bearing 200. This means that the slide bearing 200 with the first and/or second dampening elements 218, 220 provides tolerance compensation in all directions around the first guide post 108. The first O-ring 218 and the second O-ring 220 all mean that the slide bearing 200 will remain aligned in a parallel direction with the guide post axis C-C which means the first guide post 108 is less likely to jam against the slide bearing 200.

The first O-ring 218 and the second O-ring 220 project from the exterior surface 226 of the slide bearing 200. As shown in FIG. 7c, the first O-ring 218 and the second O-ring 220 project by a first distance D1. In some examples, both the first O-ring 218 and the second O-ring 220 project from the exterior surface 226 of the slide bearing 200 by the same amount e.g. the first distance D1. In some examples, the first distance D1 is between 0.1 mm to 2 mm. In some examples, the first distance D1 is between 0.32 mm to 0.63 mm. In some examples, the first distance D1 is 0.475 mm. In some examples, the first O-ring 218 and the second O-ring 220 are configured to project beyond the exterior surface 226 of the slide bearing 200 even when deformed due to a force exerted by the first guide post 108.

The first O-ring 218 and the second O-ring 220 engage an interior surface 230 of the housing 102 when the slide bearing 200 is inserted in the reciprocal bearing hole 202. In this way the first O-ring 218 and the second O-ring 220 engage both the exterior surface 226 of the slide bearing 200 and the interior surface 230 of the housing 102. This means that the slide bearing 200 is held in place within the reciprocal bearing hole 202 due to a friction fit between the reciprocal bearing hole 202, the first and second O-rings 218, 220 and the slide bearing 200.

In order to accurately position the first O-ring 218 and the second O-ring 220 on the slide bearing 200, the slide bearing 200 comprises a first circumferential groove 232 and a second circumferential groove 234. The first O-ring 218 is configured to be seated in the first circumferential groove 232. Likewise, the second O-ring 220 is arranged to be seated in the second circumferential groove 234.

The first and second circumferential grooves 232, 234 retain the first and second O-rings 218 and 220, so that when the slide bearing 200 is seated in the reciprocal bearing hole 202, the first and second O-rings 218, 220 remain fixed with respect to the slide bearing 200.

The first circumferential groove 232 and the second circumferential groove 234 are shown in FIG. 7b. The first and second circumferential grooves 232 and 234 are located either side of the slide bearing midpoint 228. Accordingly, the first and second circumferential grooves 232 and 234 are equally spaced from the slide bearing midpoint 228. Furthermore, the first circumferential groove 232 is positioned at a third distance D3 from the second bearing end 236. Likewise, the second circumferential groove 234 is positioned at a third distance D3 from the first bearing end 224. The first circumferential groove 232 and the second circumferential groove 234 are spaced the same distance (D3) respectively from the first bearing end 224 and the second bearing end 236.

Indeed, in some examples the slide bearing 200 is symmetrical about the slide bearing midpoint 228. This means that the slide bearing 200 is not directional and can be assembled more easily.

In some examples, the third distance D3 is between 3 mm to 6 mm. In some examples, the third distance D3 is 4 mm±0.1 mm.

In some examples the depth of the first circumferential groove 232 and the second circumferential groove 234 is 1 mm, 1.025 mm, 1.05 mm, 1.075 mm, 1.1 mm or any other suitable depth. In some examples the depth of the first circumferential groove 232 and the second circumferential groove 234 is between 0.95 mm to 1.025 mm.

The width of the first circumferential groove 232 and the second circumferential groove 234 is equal to a second distance D2. The second distance D2 is a similar diameter to the cross-sectional diameter of the first and second O-rings 218, 220. In some examples, the second distance D2 is between 1 mm to 3 mm. In some examples, the second distance D2 is 2 mm±0.05 mm.

The slide bearing 200 as shown in FIG. 7c optionally comprises a chamfered portion 238 at the first bearing end 224 and the second bearing end 236. The chamfered portion 238 allows the internal guide post 212 to slide easily in and out of the slide bearing 200.

Accordingly, the slide bearing 200 comprising at least one dampening element 218 provides a dampening function. At the same time the slide bearing 200 provides tolerance compensation for varying tolerances of the housing 102 and the first guide post 108. This is because the deformable at least one dampening element 218 can be inserted into the reciprocal bearing hole 202 and engage the first guide post 108 over a range of differently sized diameters of the first guide post 108.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealised or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

We claim:

1. A power tool comprising:
a housing;
a motor mounted in the housing and operatively connected to a tool holder arranged to hold a cutting tool bit;
at least one guide post having a longitudinal axis slidably mounted to the housing such that the housing is moveable in a direction parallel with the longitudinal axis between a retracted position and a plunged position;
a base portion fixed to the at least one guide post;
a slide bearing mounted between the housing and the at least one guide post wherein the slide bearing is slidable with respect to the at least one guide post when the housing moves between the retracted position and the plunged position;
wherein the slide bearing comprises at least one dampening element arranged to dampen movement of the at least one guide post with respect to the housing in a direction perpendicular to the longitudinal axis.

2. The power tool according to claim 1, wherein the at least one dampening element is configured to engage an interior surface of the housing.

3. The power tool according to claim 1, wherein the slide bearing comprises a first groove for receiving the at least one dampening element.

4. The power tool according to claim 1, wherein the at least one dampening element is an O-ring mounted on an exterior surface of the slide bearing.

5. The power tool according to claim 1, wherein the slide bearing comprises a first dampening element and a second dampening element.

6. The power tool according to claim 5 wherein the second dampening element is configured to engage an interior surface of the housing.

7. The power tool according to claim 5, wherein the slide bearing comprises a first groove for receiving the first damping element and a second groove for receiving the second dampening element.

8. The power tool according to claim 5, wherein the second dampening element is an O-ring mounted on an exterior surface of the slide bearing.

9. The power tool according to claim 5, wherein the first dampening element and the second dampening element are positioned equidistant from a midpoint of the slide bearing along a bearing longitudinal axis.

10. The power tool according to claim 9, wherein the first dampening element and the second dampening element project the same distance from the exterior surface of the slide bearing.

11. The power tool according to claim 1, wherein the slide bearing comprises an internal chamfer at a first bearing end and a second bearing end.

12. The power tool according to claim 1, wherein the housing comprises a shoulder portion for receiving the slide bearing.

13. The power tool according to claim 1, wherein an internal guide post is mounted to the housing and configured to move within the at least one guide post when the housing moves between the retracted position and the plunged position.

14. The power tool according to claim 1, wherein the slide bearing does not dampen movement of the at least one guide post with respect to the housing in a direction parallel to the longitudinal axis.

15. The power tool according to claim 1, wherein the power tool comprises a housing return spring configured to bias the housing towards the retracted position.

16. The power tool according to claim 1, wherein the power tool is a router, a plunge router, a plunge saw, a drill, a multitool, or an oscillating tool.
